(19) United States
(12) Patent Application Publication
(10) Pub. No.: US 2006/0073808 A1
(43) Pub. Date: Apr. 6, 2006

(54) System and method for control of air time of communication devices

(76) Inventor: Claude Charles Buchert, Los Angeles, CA (US)

Correspondence Address: HOLLAND & KNIGHT LLP, 633 WEST FIFTH STREET, TWENTY-FIRST FLOOR, LOS ANGELES, CA, 90071-2040, US

(21) Appl. No.: 11/230,946

(22) Filed: Sep. 20, 2005

Related U.S. Application Data
(60) Provisional application No. 60/611,352, filed on Sep. 20, 2004.

(51) Int. Cl. H04M 11/00

(52) U.S. Cl. 455/406

(57) ABSTRACT

The present invention relates to a system for providing wireless communication services, audio and multimedia contents and services, live services and financial services from a cellular phone to individual users where total or partial control of all outgoing and incoming communications, of all phone numbers (including cellular phone number, destination numbers, caller identification number, services phone numbers), of all customers accounts and billing processes, resides in the invention and may be performed in total independence of the contracted wireless carrier.

### CROSS-REFERENCE TO RELATED APPLICATIONS

This application claims the benefit of U.S. Provisional Patent Application Ser. No. 60/611,352, filed on Sep. 20, 2004.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

Many people rely on the convenience of their cellular phones for staying in touch and value the security of being able to make a call at anytime. For international travelers, the convenience and necessity of being able to stay in contact with people back home or for trip planning during the travels is especially important. In order to use the cellular phone in a foreign country, however, the choices are limited and sometimes very expensive. Even though many U.S. carriers have international roaming agreements, a user's current phone will not necessarily work in a foreign country nor is this the least expensive approach. Alternatively, one can purchase a GSM (Global System for Mobile Communications) cell phone, which will be compatible with telecommunications networks in most countries, and purchase Subscriber Identity Module (“SIM”) cards (a small chip that slides into the phone) to allow service in that particular country.

However, the typical telecommunications systems heretofore in use involve wireless carriers handling the incoming and outgoing calls as well as all user information associated with each individual account. In this case, there is often little flexibility in the kind of plans in which the user can participate, especially if he or she would prefer to pre-pay for services instead of signing a term-contract. In addition, travelers may wish to take advantage of services in addition to sending and receiving calls while traveling abroad, such as access to voice mail, multimedia messaging services, financial services, and concierge and interpreter services.

Some known systems and methods disclose services such as “on demand” interpretation services provided by telephone and paid for through the use of a pre-paid debit or credit card. It is also known that the interpretation services may be associated with cell phone service. However, the phone service is still discretely provided by the mobile carrier, and the user account information dealing with the assisted call is separately handled.

It is desirable to obtain total control over the airtime use of cellular phones or other wireless communication devices to combine services and gather user information associated with the services in one place.

### BRIEF SUMMARY OF THE INVENTION

The present invention relates to a system for providing wireless communication services, audio and multimedia contents and services, live services and financial services from a cellular phone to individual users where total or partial control of all outgoing and incoming communications, of all phone numbers (such as, cellular phone number, destination numbers, caller identification number, services phone numbers), of all customers accounts and billing processes, resides in the invention and may be performed in total independence of the contracted wireless carrier.

An embodiment of the present invention resides in a system and method for programming, transforming and manufacturing cellular phones and/or certain electronic and mechanical components of cellular phones, and programming a telecommunication platform, software and databases. The modifications made on the cellular phone handset may limit the traditional features of the handset and, because of these limitations, bring new features that were not previously available.

Various embodiments of this invention may provide a system and a method for the control of airtime of a communications device, while offering international travelers various services, such as native language communications, live assistance, live interpretation services, live concierge services, customized audio content, and financial services.

Applications of the present invention may also provide a system and a method to control, via programming telecommunications equipment, all incoming and outgoing communication to a cellular phone, with all services and billing processes of the invention performed in total independence of the contracted wireless carrier.

### BRIEF DESCRIPTION OF THE DRAWINGS

FIG. 1 is flowchart providing an overview of the an embodiment of the architecture of the present invention.

FIG. 2 is a flowchart illustrating two iterations of how outgoing calls may be handled in the system in one embodiment of the present invention.

FIG. 3 is a flowchart illustrating one embodiment of the present invention in which incoming calls may be handled in the system and method of the present invention.

FIG. 4 is a flowchart illustrating an embodiment of the present invention in which outgoing calls are handled by the call back system and method of the present invention.

FIG. 5 is a flowchart illustrating one embodiment of the present invention in which a cellular phone handset of the present invention may be purchased through a vending machine using the system and method of the present invention.

FIG. 6 is a flowchart illustrating one embodiment of the present invention showing a sequence of display screens that may be used to prompt a user to purchase a cellular phone handset of the present invention through a vending machine.

### DETAILED DESCRIPTION

The architecture of the system of the present invention may include some or all of the following provisions. This description is provided for illustration only. Many changes to this architecture would be encompassed by the present invention. While the following description contains numerous specific details (such as number key combinations, number of phones or other architectural elements, or functions or services provided), these details are described in order to provide a more thorough description of the present invention. In addition, the present invention is described in terms of a cellular telephone system, but would work as well with other types of wireless handheld communication devices. Particularly, the term “cellular phone handset” or “handset” is intended to describe any portable device that allows a user to access a cellular or other wireless communication network, and is not intended to be limited to the particular embodiment of the contemporary “cell phone.” It will be apparent, however, to one of ordinary skill in the art, that the present invention may be practiced without these specific details. In other instances, well-known features have not been described in detail so as not to unnecessarily obscure the present invention.

I. The Provider and the Wireless Carrier

One embodiment of the invention, which may be present in one or more embodiments, relates to a system and method of using two cellular phone numbers for a customized cellular phone handset of the present invention. The first phone number may be referred to as a “secret phone number,” which identifies the handset to the Provider. The cellular phone handset (hereinafter, the “handset”) is preferably programmed to identify the handset to the wireless carrier. This secret phone number may be managed by, and only known to, the wireless carrier and the Provider. This number may not be known by the user or any other third party. The second phone number, which may be referred to as the “public phone number,” identifies the handset to third parties and to the Provider's telecommunications platform. This number may be a landline phone number, which is preferably issued and managed by the Provider, and is known to the user, but is not known to the wireless carrier.

In a method of the present invention, the wireless carrier's function may be limited to merely connecting the incoming and outgoing calls of the wireless handset to the Provider's platform using the “secret phone number.” The wireless carrier does not handle the dialing of the destination number. Because of this, the wireless carrier does not know the destination number of outgoing calls. The wireless carrier does not know the “public phone number” used by the user to receive incoming calls. The wireless carrier does not know the caller identification number (“caller id”) of the third party calling the user's cellular phone. The wireless carrier does not and cannot manage the account balance and the billing of the Provider's cellular phones. The wireless carrier has no relation whatsoever with the user. The wireless carrier does not even assign the “public phone number” to the user's phone for the utilization of the cellular phone handset by the user. The Provider may manage all outgoing calls, all the caller identifications, all the assignments of “public phone numbers,” all the destination numbers, the management and billing of all user's accounts for all outgoing and incoming calls, and access to all services, in total independence of the wireless carrier.

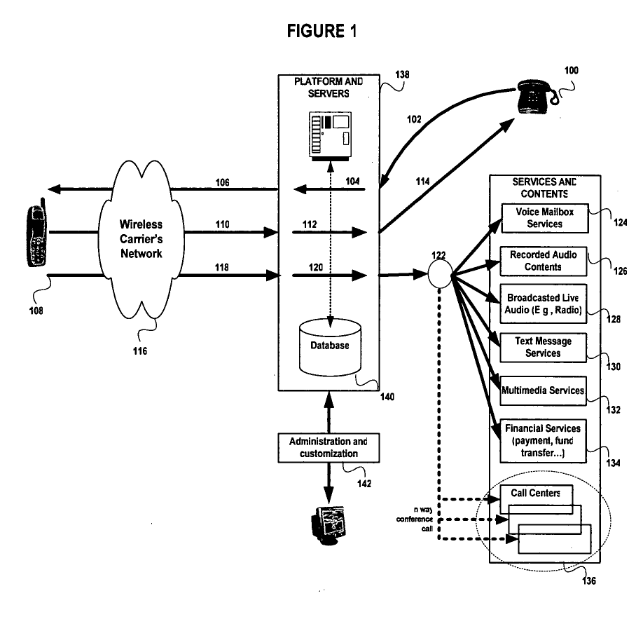

Referring to FIG. 1, an embodiment of the overview of the invention can be seen. When a third party 100 dials the “public phone number” of cellular phone handset 108, an incoming call is initiated (step 102). Provider Platform 138 receives the incoming call in step 104 and forwards the call to handset 108 by dialing its “secret phone number.” The wireless carrier's network 116 then connects the call to handset 108 in step 106.

Outgoing calls are handled similarly. In one embodiment, in step 110, the user of cellular phone 108 obtains Provider Platform 138's dial tone by pressing a designated key. In step 112, the user dials the destination number. The process is completed in step 114 when the platform initiates the call to the destination party.

To access services, the cellular phone user can choose a service by pressing the corresponding key in step 118. In step 120, Provider Platform 138 receives the service request and checks the user's parameters in database 140. If the parameters are satisfied (e.g., the user's account is current), then the platform connects the user to the corresponding service in step 122. The services and contents may include but are not limited to: voice mailbox services 124, recorded audio contents 126, broadcasted live audio 128, text message services 130, multimedia services 132, and financial services 134. The user may also access call centers 136 to engage in multiple way conference calls. Finally, administration and customization of the user protocol and services may be customized remotely or over the Internet in step 142.

II. Control of All Outgoing and Incoming Calls

Outgoing Calls

The present invention's preferred method of control of outgoing calls resides in programming, restricting, modifying, enhancing or otherwise controlling cellular phone handset 108's standard and advanced functions to direct all outgoing calls to Provider Platform 138. In addition, the present invention contemplates several methods for making outgoing calls that gives Provider Platform 138 the total control over dialing the destination number.

Restricting, Modifying or Enhancing the Cellular Phone Handset Functions for Outgoing Calls

In a preferred embodiment of the present invention, outgoing calls are connected through Provider Platform 138. The invention restricts cellular phone handset 108 to obtaining the Provider dial tone in order to make outgoing calls. This may be done by one or several of the following exemplary methods: setting up the handset menus; reprogramming the handset operating system; modifying, removing or adding electronic or mechanic parts or components in the handset; manufacturing and programming a handset or handset component (e.g., a Subscriber Identity Module (SIM) card) and corresponding operating system, software and encryption method or other methods known to those of skill in the art.

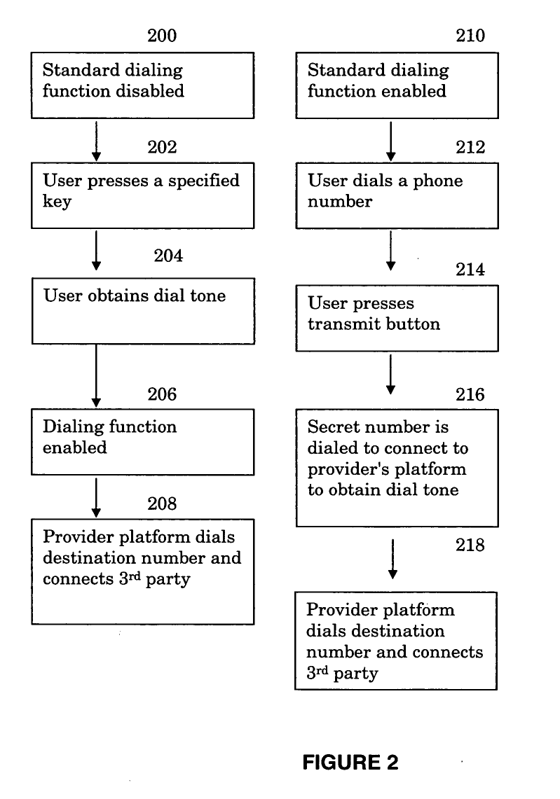

In one embodiment of the present invention, the method of restricting the cellular phone's access to outside dial tones makes it impossible for the cellular phone to make calls without first obtaining Provider Platform 138 dial tone. Two examples of how this can be done are shown in FIG. 2.

Methods for Making Calls Using the Method of the Present Invention.

Referring to FIG. 2, by prior programming, the system of the present invention may disable basic dialing functions at step 200. The user first obtains the Provider dial tone before dialing the destination number by pressing a specified key (for example, key #2) for a specific short time period (such as two seconds) as in step 202. When the Provider dial tone is received in step 204 the user may then dial the destination number in step 206.

Before Obtaining Dial Tone:

Each key's basic function of dialing its own key number may be inhibited by the method of the present invention. Consequently, it would be impossible to dial a phone number before obtaining the Provider dial tone, as illustrated in step 200. Each key (or combination of keys) may be programmed to have the function of connecting to one of the Provider's services. One of the keys (e.g., key #2) should be dedicated to obtaining the Provider dial tone.

After Obtaining Dial Tone:

Each key of the handset may retrieve its basic function of dialing its own key number. For example, in step 206, a destination call number may then be dialed by the user. In one embodiment of the invention, there is no need to press any additional key after the destination number (such as SEND, TALK, or #). Once the destination number is dialed, the corresponding third party is contacted by Provider Platform 138, as shown in step 208.

Another embodiment of the present invention may control outgoing calls as follows: Step 210 shows that the basic dialing function is enabled at the outset. In step 212, a user would dial a desired destination number normally, then press a function key; such as, for example, the SEND or TALK key, as in step 214. When pressing the SEND or TALK key, the following is performed automatically by the present invention: The destination number is not dialed immediately; instead, a substituting number, stored in the phone or the SIM card and corresponding to the SEND or TALK key, is automatically dialed followed by a pause (a few seconds) and by the destination number at step 216. This substituting number connects to Provider Platform 138 in order to obtain the Provider's dial tone. The pause allows Provider Platform 138 to get ready to dial the destination number. Provider Platform 138 automatically dials the destination number entered initially by user in step 218.

For both illustrative embodiments described above, the wireless carrier does not know the destination number dialed by the user. The wireless carrier does not handle the dialing of the destination number. Only Provider Platform 138 handles this operation.

Outgoing Calls by Call Back

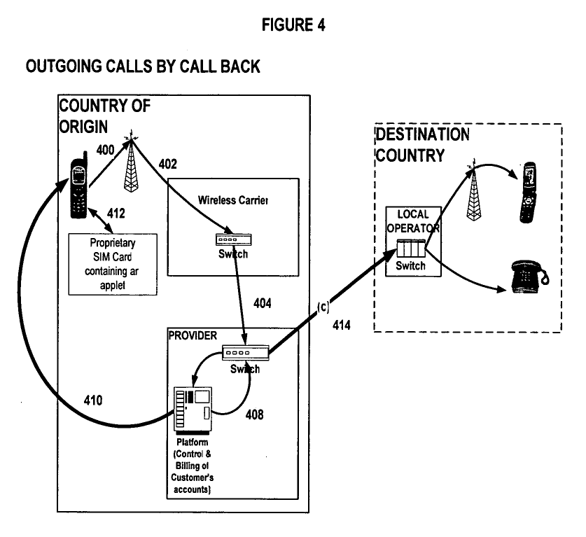

This embodiment of the present invention is intended to transparently and seamlessly enable a user to make a normal outgoing call by having Provider Platform 138 connect the call between the calling party and the destination party, and joining the communication so as to initiate an outgoing call. FIG. 4 gives an overview of the architecture and process of this feature. Referring to FIG. 4, the detailed steps are the following: First, user dials the destination number in step 400 and presses a transmit key, such as the SEND or TALK key, to initiate the call. Second, cellular handset 108 contacts Provider Platform 138 (through a regular telephone call or by sending a Short Message Service (SMS) or by any other method know to those of skill in the art) in step 402 and transmits the Secret Phone Number (Caller ID) associated with cellular handset 108 and the destination number to Provider Platform 138 in step 404. Third, Provider Platform 138 does not pick-up the call but captures the Caller ID and the destination number and keeps the call pending in step 408. Fourth, Provider Platform 138 calls the handset back with the Caller ID in step 410. Fifth, through programming, cellular handset 108 recognizes the incoming call as a “call back” call and does not make the handset ring but instead connects the incoming call on cellular handset 108 with the pending outgoing call so that cellular handset 108 and the platform are connected on a handset outgoing call mode in step 412. Sixth, Provider Platform 138 calls the destination number and connects the call between cellular handset 108 and Provider Platform 138 with the destination number in step 414. All this process is transparent to the user, who simply makes what appears to be a normal outgoing call.

Access and Use—Associated User Services

Each key or combination of keys on cellular handset 108 may be assigned to a specific associated user service in the system of the present invention. User services may be provided by the Provider or by other organizations or vendors associated with the Provider as shown in FIG. 1. One preferred method of providing access to the associated user services is where a user may, in one embodiment, press a designated or possibly dedicated key (or the last key of the combination of keys) for a short time, such as two seconds, whereby Provider Platform 138 responds by connecting the user with the corresponding associated user service. Examples of associated user services which might be provided using the system and method of the present invention include, but may not be limited to, the following: making local, long-distance and international calls, accessing voice mailbox services and answering systems, accessing an operator for information and services, accessing pre-recorded audio contents, accessing live contents (such as live radio or music), accessing text message services, accessing multimedia messaging services, accessing financial services (for example, making bill payments and/or transferring funds among accounts.

It can be seen by one of ordinary skill in the art that in one embodiment of the invention, the wireless carrier, having no knowledge of the secret phone number nor access to the cellular phone handset, other than through a connection by the platform of the present invention, does not have knowledge of, nor have access to, nor provide the associated user services.

Incoming Calls

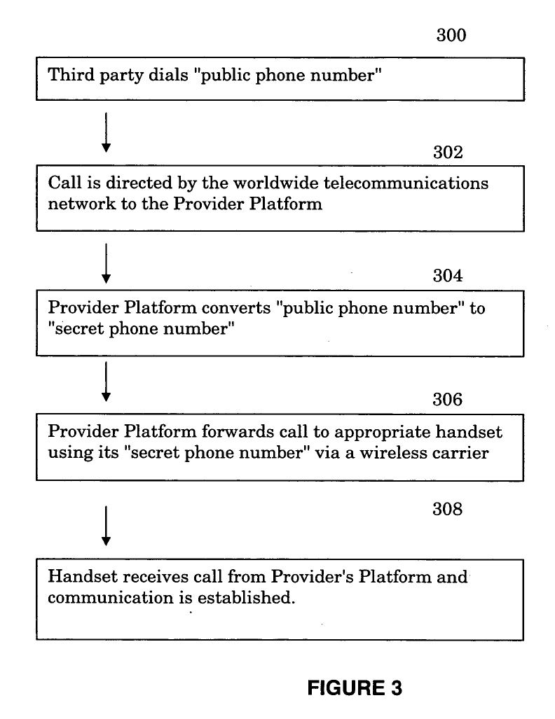

FIG. 3 gives an overview of the general incoming call process. Referring to FIG. 3, step 300 shows that when a third party wishes to call the user of the present invention, the third party dials the “public phone number” of the cellular handset 108 of the present invention. In step 302, the call is directed by the worldwide telecommunications network to Provider Platform 138, to whom the number is assigned, in the manner of a traditional telecommunications connection. In step 304, recognizing the “public phone number,” Provider Platform 138 detects and accepts the call. Through any of a number of means well known to those of ordinary skill in the art, such as table look up (step 304), Provider Platform 138 matches the “public phone number” to the “secret phone number” and forwards the call to the corresponding cellular handset 108 of the present invention through the wireless carrier's network by calling the “secret phone number” associated with the corresponding “public phone number” in step 306. In a preferred embodiment of the present invention, the incoming call is always directed to Provider Platform 138 because of the use of the public number/secret number approach. Thus, a third party cannot directly connect to cellular handset 108 without connecting through Provider Platform 138, because the “secret phone number” is not known nor accessible to the user or the third party. Thus, cellular handset 108 may receive calls from any other device connected to the worldwide telecommunications network, but only after the call has been forwarded to the handset by Provider Platform 138.

Step 308 indicates that cellular handset 108 of the present invention may be customized to reject any call that does not come from Provider Platform 138 using standard programming techniques applicable to programmable cellular handsets. Thus, even if a third party dials the “secret phone number” by mistake, the handset may not accept the call.

As will be discussed below, for billing purposes and other reasons apparent to one of ordinary skill in the art, it is a preferred embodiment of the invention that the wireless carrier does not know the cellular phone number dialed by the third party or the caller identification phone number of the third party. The “public phone number” known by the user and his contacts is generated by means familiar to those of ordinary skill in the art, by Provider as part of the system of the present invention.

III. Setup and Customization of the Phones' Features

Remote Customization of the Global Behavior of the Handset for Outgoing and Incoming Calls

Cellular handset 108 of the present invention may be configured to operate with one or more additional features installed in the method and system of the present invention. The present invention contemplates that such additional features may be removed, modified or added remotely to cellular handset 108 by the Provider or any third party authorized by Provider, allowing the Provider to remotely and instantly remove, modify or add part or the entire application that dictates how the cellular is supposed to behave. In the case of a SIM card, this customization may be made by the OTA (Over The Air) functions of the wireless carrier or by SMS (Short Message Service) or by any other similar means presently existing or to come.

Initially, in one or more embodiments of the present invention, each cellular handset 108 may be set up with generic features and with the language of the customer. Once cellular phone handset 108 is in the hands of the user, all features associated with each key of a phone may be instantly and remotely updated through various electronic means. For example, in one embodiment of the invention a web-based interface program which is accessible by the Provider to fit user's characteristics and preferences could serve this purpose. In one or more embodiments of the invention, any authorized third party, including the user, may be given access to the electronic interface such as a web-based interface program to allow control and modification of the features of the phone. Technical details and design of such web-based access programs are well known to those of ordinary skill in the art, and so not discussed here so as to avoid obscuring the present invention.

Remote Customization of the Default Language

In one or more embodiments of the present invention, each service may be configured to be accessible in the default language associated with the phone. The default language may be changed for each phone, depending on the preferences and native language of the user. If the default language has been changed for a given cellular phone handset 108, all the services and contents accessible by that phone may be made accessible in the new language.

An example of a feature or service in one or more embodiments of the present invention would include providing “live services” through call center operators and may be provided in the default language associated with the user's phone. Audio contents such as radio, weather or horoscope may be provided in the language of the user.

Remote Customization of Each Key

In one or more embodiments of the present invention, each key of each phone in the present invention may be remotely customized to be associated with one or more services accessible from cellular handset 108.

At any time, a new service or content may be made accessible through a new key to all current users at once, or to only one user or a group of users who agree to subscribe to the new service or content. For example, at a certain date, the Provider may offer stock trading information and may associate this new content to button #34. All selected users could then be able to access this new content at the exact same time, and it the user's preferred language, without having to do take any action. The Provider may, in one or more embodiments of the present invention, remotely make new services and content available to all users instantly. A Japanese-speaking user would be able to access the new content in Japanese. A French-speaking user would be able to access the new service in French, using the same button on the handset, and without having to do anything different than the Japanese user. In view of the present disclosure, other examples of such services will be apparent to those of ordinary skill in the art.

Remote Customization of Each Service

In one or more embodiments of the present invention, a generic service may be associated to a given key on cellular handset 108, the features and/or content may be customized depending on customer's preferences or may be dynamically assigned, for example, depending on customer's geographical location at a certain time. This may be accomplished using a specific button on cellular phone handset 108 that may be set to a specific service or a customized service. For example, pressing number 8 could give access to weather in New York to a user located in New York, and may automatically and dynamically change to provide weather in Los Angeles when that user travels with the handset to Los Angeles, depending on the user's specified preferences. It could also be desirable to always have number 8 provide the weather at the user's home location. Thus, customization of each service is desirable and contemplated by the present invention. Methods to map services to particular handset keys are well known in the art, and so are not detailed herein, while having user preferences allow customization of key-based associated services are particularly contemplated as part of the method and system of present invention.

IV. Real-Time Combination of Services through Multiple-Way Conference Calls

The user may access more than one service at the same time through a multi-way conference call system. In FIG. 1, multi-way conference call 122 indicates that the user is in contact with more than one person or service or audio/multimedia content at the same time. The initiation of conference call 122 may be made by several methods. All communications may be automatically or manually initiated by the user at the same time. Additionally, communications may be initiated one after the other, either automatically after a period with a updatable duration, or manually by the user or by an authorized operator. Another method contemplated by the present invention includes each communication being initiated for a specific duration or for unlimited usage.

In one embodiment of the invention, several call centers 136 may be joined together on a multiple-way conference call (for example, an English/Japanese translation call center and an English-speaking concierge call center may be joined to provide concierge services in Japanese language), as illustrated in FIG. 1 at step 122. Any authorized party may initiate an additional communication, or stop a communication by dialing a code (for example, #31). Thus, several third parties may be put together within the same conference call without knowing each other and without prior knowledge of each other's phone numbers by the method of the present invention.

V. Billing

The present invention also encompasses related methods for billing users for services provided by the system and methods of the present invention.

General Billing Methods

All outgoing calls, incoming calls and service usages may be either free for the user, prepaid or postpaid, billed per minute or per action or both. All rates may be managed on Provider Platform 138. Different rates may be managed for different groups of users. Rates may be different depending on the service used or the destination country for outgoing calls or the option chosen by caller to reach the cellular phone. Rates may be different depending on country where the handset is used and the country from where the cellular phone is called from.

In one or more embodiments of the present invention, the user may be billed in real time against his prepaid balance or directly to his credit card. The user may also be post-billed later on his credit card or with other payment methods.

The present invention also contemplates that a user may recharge his account by paying the Provider directly with his credit card or by any other method of payment; such as cash, check or other method of funding. “Recharging” the user's account may be done instantly, or later after verification of payment, using methods familiar to those of ordinary skill in the art.

Outgoing Calls

In one or more embodiments of the present invention, all outgoing calls include the option of billing different rates in different countries, corresponding to a rate table organized by destination country. Calls may be billed per minute, per flat fee before, after or several times during the call. Additional charges may be billed at different frequencies; such as by the day, week, month.

Incoming Calls

In one or more embodiments of the present invention, incoming calls may be billed the same way as outgoing calls with the additional following options and example embodiments:

International Communication for the Caller

The caller calls directly the “public cell phone number” and is charged by his local telecommunications company for the international communication. The cell phone user may be charged by the Provider for the incoming call.

Local Communication for the Caller

The caller calls a local “public cell phone number” in his own country and may be charged by his local telecommunications company for the local call. The call is automatically forwarded to the corresponding cell phone wherever in the world it is being used at that time using the system and methods described herein. The cell phone user may be charged by the Provider for the international communication and the incoming call.

Free Communication for the Caller

The caller calls a local toll-free number in his own country and is not billed for the call. The communication reaches Provider Platform 138 and the caller is prompted for the “public cell phone number.” The caller enters the “public cell phone number” and Provider Platform 138 connects the call to the cellular phone handset 108 of the present invention. The user may be charged by the Provider for the toll-free number call, the international communication and the incoming call. Such an option, for example, may be advantageous to business travelers who wishes to be available to clients during travels, but does not want the clients to be billed for calling him. This embodiment of the present invention provides an attractive alternative.

Services

In one or more embodiments of the present invention, each service the user accesses may be billed to the user at varying rates depending on the service selected (see section on General Billing Methods herein for methods of determining and managing billing of Services and Contents such as those illustrated in FIG. 1).

Combination of Service through Multiple-Way Conference Calls

When several services are used at the same time, such as during a translated multi-way conference call, the present invention contemplates that each service may be billed separately and consolidated on the user's account.

VI. Financial Features

Introduction

The present invention contemplates that customized cellular phone handset 108 of the present invention may also be used for financial transactions; such as payment, fund transfer and cash withdrawals.

Storage and Encryption of Information

Another use for customized cellular handset 108 might be secure user identification, which may be encrypted on handset 108, on a smart card, a SIM card, a hard disk or other encrypted data storage medium of the present invention. User identification may be performed using any method familiar to those of skill in the art; such as an encrypted code, fingerprint identification or other biometric data, if handset 108 is so equipped, or other identification systems well known to those of ordinary skill in the art.

It will be clear to those of skill in the art, given the disclosure herein, that financial information (such as account balance, credit card information, bank account balance, authorized amounts for financial transactions, currency information and other financial information) may also be encrypted by and accessed using cellular phone handset 108 of the present invention via the same types systems listed herein.

Connection between Handset and Terminal

For payment and other secure purposes, communication may be established between cellular phone handset 108 and a payment device or function; such as a merchant payment terminal. In a preferred embodiment of the method of the present invention, this communication may be by wireless connection; such as via systems such as Wi-Fi, Bluetooth, wireless phone, GPS, other radio frequency system or other future wireless communication systems.

Financial Transactions

Cellular phone handset 108 of the present invention may also be used as the unique tool to perform one or more type of financial services transactions 134 or may be used as an electronic wallet allowing performing virtual financial transactions 134.

Payment for Goods and Services

Once the connection is established, data may be exchanged between the merchant terminal and cellular handset 108 to authenticate both merchant and user's financial accounts and identities, and to process payment through secured technical and financial networks. Before a financial transaction, both user and merchant may need to accept the transaction amount on their respective device, such as cellular handset 108 for user and the terminal for merchant.

Discounts and commissions for both user and merchant may be calculated automatically and instantly by Provider Platform 138 and corresponding amounts may be credited and debited to corresponding accounts.

Electronic Fund Transfer

In one embodiment of the invention, the user may use cellular handset 108 and the Platform of the present invention to transfer funds electronically. The user may first authenticate himself via cellular handset 108 (via code or fingerprint or other authentication method), and then provide the information required to perform the transaction (such as information about accounts to be credited and debited, currency to use, amount to be transferred) and validate a transaction.

All known values (such as commissions, fees, currency conversion rates) may be calculated automatically and funds may be immediately and securely transferred via the method of the present invention.

Cash Withdrawal

To perform a cash withdrawal, a user of the present invention may be required to authenticate himself via cellular handset 108 (using a PIN code or fingerprint or other authentication system, as described above), to provide information on accounts to be debited and on currency, to provide the amount to be withdrawn, and to validate the transaction.

The present invention contemplates programming cellular phone handset 108 to communicate wirelessly with appropriately configured cash withdrawal terminals as described herein. Once a transaction is validated through the Platform, cash and receipt may be provided by cash withdrawal terminal to the user.

VII. Additional Services and Content Options

Several “Public Cell Phone Numbers” for Each “Secret Cell Phone Number”

In one or more embodiments of the present invention, the Provider may use database 140 to associate several “public cell phone numbers” to each “secret cell phone number.” If so configured, database 140 may allow multiple associations to depend, based on user preferences, on which country cellular phone. Thus, for a cell phone used, for example, in the United States, its “secret cell phone number” may be associated to:

In one or more embodiments of the present invention, one or more “public cell phone numbers” in the multiple countries may be may be associated with a given cellular phone handset 108. For example, in the United States, numbers in multiple area codes (such as 213 xxxx-xxxx and 310 xxx-xxxx) in Los Angeles, and one or more “public cell phone numbers” in Japan (03 xxxx-xxxx and 03 yyyy-yyyy), along with one or more “public cell phone numbers” in additional countries, may all be associated to a given cellular phone handset 108 for a traveler, for example, moving between these locations on a given trip. In view of the present disclosure, other possibilities to exploit this capability of the present invention may be realized by those of ordinary skill in the art, and are encompassed by the present invention. This feature of one or more embodiments of the invention to allow multiple “public” numbers, as well as “multiple” secret numbers, to be associated with a given handset 108, provides added flexibility desirable to the user of the invention.

Several “Secret Cell Phone Numbers” for Each “Public Cell Phone Number”

Two (or more) different cell phones of the present invention may be called at the same time by one caller, in one or more embodiments of the invention. Fore example, a caller may dial a “public cell phone number,” the communication reaches Provider Platform 138, which may then simultaneously call two (or more) different “secret cell phone numbers” and manage the conference call as soon as each cell phone user answers their respective cellular phones.

Pre-Recorded Audio File or Broadcasted Audio Feed

One embodiment of the invention contemplates a user pressing one key on cellular handset 108 to provide access a pre-recorded audio file 126, which may be located on various sources; such as on one or more of the Provider's servers, on other (third party) servers, which may or may not be associated with the Provider, or which may be available for free on the Internet. In one embodiment of the invention, the user is provided with regularly updated information; such as news, music or any audio information available on the Internet or custom-produced by the Provider or some other source suggested herein.

This technology is extended to access broadcasted and uninterrupted audio feeds 128, such as those available on the Internet. In case the link between Provider Platform 138 and the audio feed is lost, a process may automatically detect the disconnection and reconnects the platform to the audio feed.

“My Personal Diary”

Another feature which might be offered in conjunction with the features of the invention described herein could include an extension of a voice messaging system, whereby the user may leave several messages that may be heard later by several authorized people who connect independently to the Provider's service. This approach could allow vacation travelers, for example, to leave messages for multiple friends and family back home about the adventures they are having on their travels—a type of travel log or “personal diary,” without incurring charges to call each individual person back home, using many minutes on their plan to repeat the same information about their day. The personal diary feature of one or more embodiments of the present invention allows flexibility by providing space on Provider Platform 138 for user's to record outgoing messages.

VIII. Vending Machine

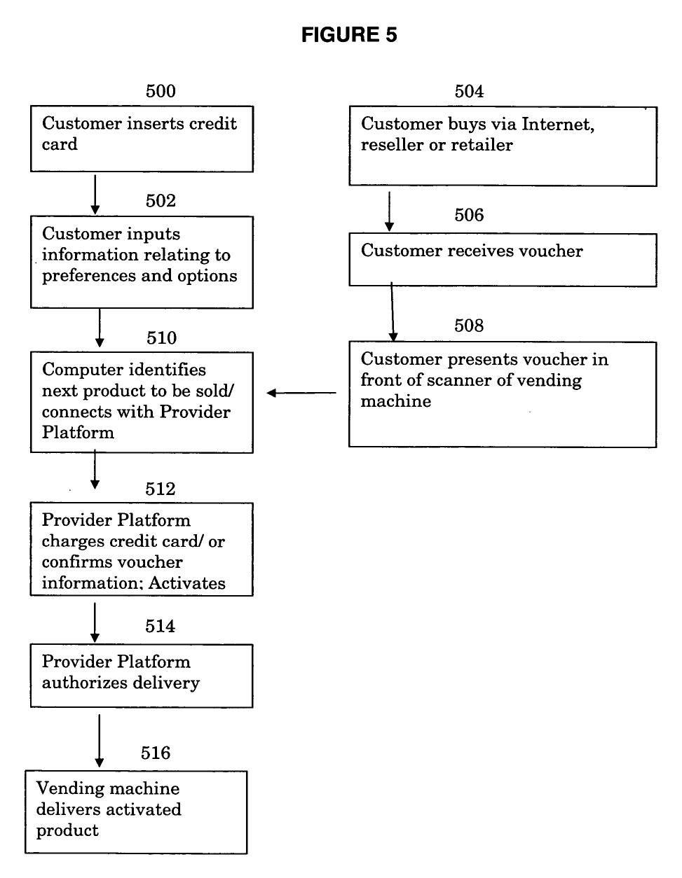

One method of selling cellular handset 108 to the user is to use a vending machine. FIG. 5 illustrates various methods of using a vending machine to sell cellular phone handset 108 to travelers or other customers. The vending machine may be dedicated to operate in public areas to store, organize, sell and/or deliver cellular phones or component of a cellular phone (for example, SIM cards, and accessories.) The vending machine may also be a communication device delivering customized messages to potential customers standing near or walking by the vending machine. In one or more embodiments of the present invention, the vending machine may include the following elements: The container relates to the main structure of the vending machine that assembles all the other components in a closed and secure box. The container structure and material may differ depending on the location (indoors, outdoors) of the vending machine. The storage and delivery system organizes the products to be sold and/or delivered and delivers the products by different technology existing or to come by placing the product in a delivery compartment accessible by customer. One or more sensors may be used to detect presence of a person nearby the vending machine and to initiate specific actions. One or several video screens may be employed to deliver audiovisual messages on a permanent basis or depending on the sensor's instructions. One or several scrolling banners may also be used to deliver specific messages with the same principles. The bar code scanner allows user to present a voucher or any other document or object identified by a bar code in order to get specific actions. The payment system allows user to make a payment with a credit card and/or with other methods of payment. This system may comprise a credit card or any other card reader, a keyboard and or specific keys allowing user to enter data. The instructions screen allows vending machine to communicate specific messages and instructions to user in order to help him go through a specific process (payment, delivery or otherwise) or for general information. One or several speakers in the vending machine might deliver an audio message to user providing general information on the system, advertising or specific instructions for using the machine. A computer in the vending machine may store data, perform specific actions and synchronizes the behavior of all the other components of the system with the vending machine. A typical computer communication interface initiates communications between the computer and a LAN (Local Area Network), a WAN (Wide Area Network), the Internet or any other network in order to connect to Provider Platform 138. This typical interface may be a modem or any other communication device capable of performing the required computer connection actions. Cellular phone handsets 108 (the products) are stored and organized by a storage and delivery system which is part of the vending system. Each product is identified by a code stored into a chip attached to the product. When product is about to be vended (delivered), this code may be remotely read by the computer to identify the product, through a wireless technology like Infrared, Bluetooth, WiFi or any other wireless communication technology presently existing or to come.

The purchase and delivery process using the vending machine is shown in FIG. 5. It begins as a potential customer is walking by the vending machine and audiovisual messages are displayed to convince him/her to purchase the product by inserting his/her credit card into the payment system of the vending machine. In step 500, the customer inserts credit card into the payment system and then in step 502 follows instructions displayed on the instructions screen to input certain requested information and to indicate his preferences. Next, in step 510, the computer identifies the next product to be sold and the communication interface initiates a connection with Provider Platform 138. In step 512, Provider Platform 138 charges the customer's credit card for the product's price and activates the product with the corresponding credit amount. Then, in step 514, Provider Platform 138 sends back to the vending machine the authorization to deliver the product that has been activated on Provider Platform 138. Finally, in step 516, the storage and delivery system delivers the activated product to the customer into the delivery compartment. If the customer's credit card is not authorized to make payments or does not have sufficient funds or for any other reason, the platform sends back to the vending machine the corresponding message that is displayed on the instructions screen to the customer and proposes him to take specific actions. Provider Platform 138 keeps track of the number of product remaining in each vending machine and automatically initiates stock replenishment actions when stock level reaches a certain level.

As shown in step 504, the customer can also purchase the product in advance through the Internet, a travel agent or any other authorized reseller or retailer. At step 506, the completion of the transaction, the customer receives a printed voucher. In step 508, the customer can then present the voucher in front of the bar code scanner and the same process is executed except for the debit of the credit card because the payment has been made in advance.

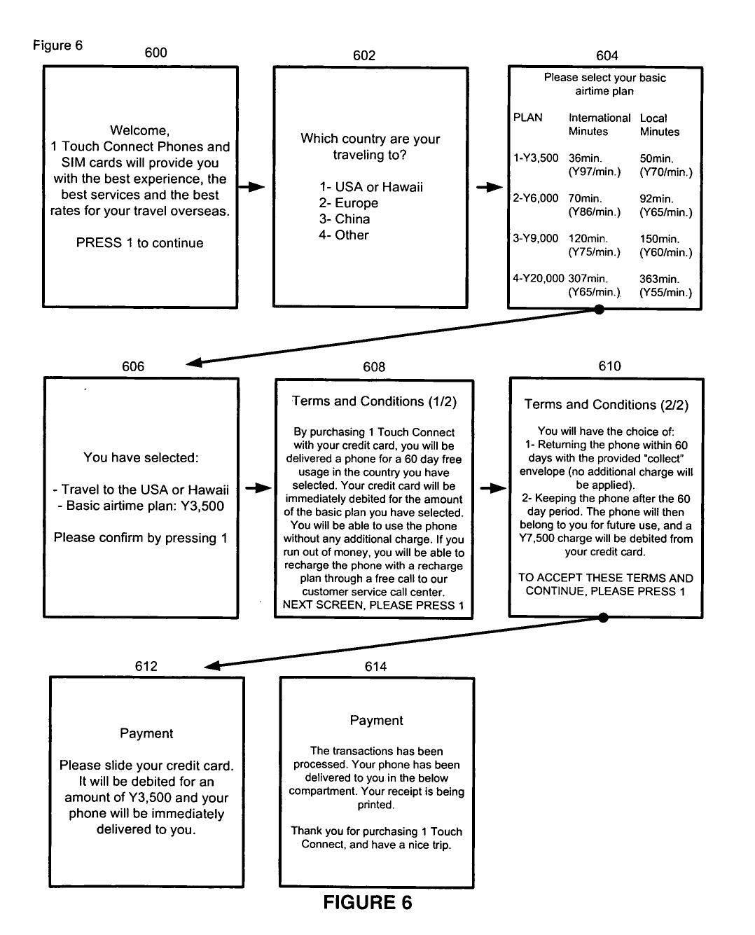

There are many possible ways to complete a transaction to purchase cellular phone handset 108 of the present invention using a vending machine. FIG. 6 gives an overview and example of the instructions and process to the customer interested in the purchase the product. Step 600 provides a welcome screen. Step 602 asks the customer to indicate which country he or she will be traveling to while step 604 asks the customer to select his or her airtime plan. Then step 606 confirms the customer's selections. After the choices have been confirmed, step 608 shows the terms and conditions connected with the use of the product and step 609 requests the customer to accept the terms in order to continue. If the customer accepts the terms, he or she is prompted to insert a credit card in step 612. Finally, step 614 informs the customer that the sale has been finalized.

IX. Online Interfaces for Remote Sales and All Other Set-Ups

The online (Internet) user interfaces of the present invention allows the Provider and its partners to perform remote actions and set-up that define how each handset 108 behaves and is customized for each customer. Methods for creating such online interfaces are well known to those of skill in the art. The following example illustrates one possible embodiment of the present invention for illustration.

Each online user interface is accessible with a User ID and a password over the Internet. Each interface is customized to know and identify available and subscribed services and content associated with the user account, which are linked to the interface using the login User ID and password. For example, for a specific User ID and password, interfaces will be displayed in a specific language and some features will be available or not depending on the authorizations assigned to this user.

Administrator Interfaces:

The administrator interface allows the administrator to add and edit distributors, add and edit customer service agents, add and edit delivery companies and add and edit pickup companies. This interface also allows the administrator to create packages. A package is one method of the present invention to associate a particular cellular handset 108 with a corresponding phone model.

The administrator interface may allow the administrator to associate a phone number with a package; in other words, the phone model the telephone number corresponds to. It also may allow the administrator to assign a stock of phones to the different parties, distributor, delivery company or pickup company, as well as allow the administrator to manage the exchange rates used to settle credit card transactions in Yens, British Pounds and Euros.

Distributor Interfaces:

The distributor interface provides at least two functions in the system of the present invention, management of users and management of orders in one or more embodiments of the present invention.

The distributor interface may allow a distributor to manage user accounts activated under its sales code. The distributor may perform basic functions such as updating the user's personal information, payment information, recharge option and adding notes. The distributor may also have the ability to deactivate the phones activated under its code.

In a preferred embodiment of the present invention, the distributor interface allows a distributor to perform activations and place orders for cellular phone handset 108. The distributor has the choice to either activate a phone on the spot when he has decided to use a handset 108 in stock, or to place an order on behalf of its customer, which will then be delivered to the customer or picked up at a pickup location by the customer.

When the distributor has placed an order on behalf of the customer or sells handset 108 online, he has the ability to track pending orders before the order is associated to a phone number and the phone activated, using the distributor interface. Also using that interface, the distributor has the ability to edit the user information, credit card information, recharge option and the comments section.

Pickup Interfaces:

The pickup interface may be used to allow a pickup agent to associate a ready-to-be-activated telephone to a preorder, which will contain all the customer personal information, credit card information, plan chosen and recharge option chosen. A pending order may be associated to a telephone number in stock at the pickup location and the phone to be activated at this time. The pickup agent only has the opportunity to update the comments section of this order, for security and other reasons apparent to those of skill in the art.

Customer Service Interfaces:

The customer service interface of the present invention provides at least two functions, management of users and management of user services in one or more embodiments of the present invention.

The management of user function may provide a search function which allows to search for an account by phone number, last name, email address, company name, cardholder's name, payment reference and order number.

Once the account has been identified, a customer service agent may update the user's personal information, credit card information, recharge option, add comments, recharge the account for the amount chosen by the customer, post adjustments, debit the user's credit card for the amount corresponding to the price of the phone (in case of no return), review the history of operations for the account and the history of calls for the account.

The management of user services function allows a customer service agent or similar employee of the Provider to configure on or more speed-dial keys for a particular cellular phone handset number. This allows the user to use the speed-dial function instead of having to dial, for example, a 2 to get a line and then dial the destination number.

It is believed that a system and method for control of air time of communication devices will be understood from the foregoing description, and it will be apparent that various changes may be made in the form, construction and arrangement of the parts without departing from the sprit or scope of the invention or sacrificing all of the material advantages, the forms herein above described being merely preferred or exemplary embodiments thereof.

What is claimed is:

1. A system for providing telecommunication services to an individual user from a wireless communication handset comprising:
at least one wireless communication handset comprising:
a first handset identification number, coupled to said at least one wireless communication handset by programming, and unknown to a user of said at least one wireless communication handset;
a second handset identification number, coupled to said at least one wireless communication handset by programming and known to said user; and
at least one telecommunications platform, coupled via programming to communicate with said at least one wireless communication handset, such that all outgoing calls from said at least one wireless communication handset are directed to said platform;
at least one wireless carrier providing wireless telecommunication services capable of connecting said at least one wireless communication handset with said platform via at least one telecommunications network; and
wherein said at least one telecommunications network directs an incoming call to said second handset identification number to said platform, said platform programmed to redirect said incoming call to said at least one wireless communication handset via said first handset identification number.

2. The system of claim 1, further comprising:
at least one user service, coupled via programming to communicate with said at least one wireless communication handset, such that said service is accessible by said user by manipulating said handset.

3. The system of claim 1, further comprising:
at least one user service, coupled via programming to communicate with said platform, which communicates with said at least one wireless communication handset such that said service is accessible to said user by manipulating said handset.

4. The system of claim 3, wherein said user service is remotely customized to suit said user's preferences.

5. The system of claim 3, wherein said at least one user service comprises at least one call center.

6. The system of claim 3, wherein said call center combines a plurality of said user services through multi-way conference calls.

7. The system of claim 1, further comprising:
a merchant payment terminal, coupled via programming to said at least one wireless communication handset, whereby said user performs a financial transaction by manipulating said handset.

8. The system of claim 1, further comprising:
a vending machine, coupled via programming to communicate with said platform, wherein said platform receives information and preferences of said user and authorizes sale and delivery of said wireless communication handset.

9. The system of claim 8, further comprising:
whereby said vending machine performs programming of said handset to communicate with said platform using said first and second handset identification numbers.

10. A computer program product in a computer-readable medium for providing telecommunication services to an individual user from a wireless communication device, the computer program product comprising:
means for coupling at least one wireless communication handset to a telecommunications platform comprising:
means for programming at least one wireless communication handset with a first handset identification number unknown to a user of said at least one wireless communication handset;
means for programming at least one wireless communication handset with a second handset identification number known to said user; and
means for at least one telecommunications platform to communicate with said at least one wireless communication handset via programming such that all outgoing calls from said at least one wireless communication handset are directed to said platform;
means for providing wireless telecommunication services capable of connecting said at least one wireless communication handset with said platform via at least one telecommunications network via at least one wireless carrier; and
wherein said at least one telecommunications network directs an incoming call to said second handset identification number to said platform, said platform programmed to redirect said incoming call to said at least one wireless communication handset via said first handset identification number.

11. The computer program product in a computer-readable media of claim 10, further comprising:
means for providing at least one user service, coupled via programming to communicate with said at least one wireless communication handset, such that said service is accessible to said user by manipulating said handset.

12. The computer program product in a computer-readable media of claim 10, further comprising:
means for coupled via programming at least one user service to said platform, said service communicating with said at least one wireless communication handset such that said service is accessible to said user by manipulating said handset.

13. The computer program product in a computer-readable media of claim 12, wherein said user service is remotely customized according to said user's preferences.

14. The computer program product in a computer-readable media of claim 12, wherein said at least one user service comprises at least one call center.

15. The computer program product in a computer-readable media of claim 12, wherein a call center combines a plurality of services through multi-way conference calls.

16. The computer program product in a computer-readable media of claim 10, further comprising:
means for a merchant payment terminal, coupled via programming to communicate with said at least one wireless communication handset, such that financial transactions is made by said user by manipulating said handset.

17. The computer program product in a computer-readable media of claim 10, further comprising:
a means for vending said handset coupled via programming to communicate with said platform, wherein said platform receives information and preferences of said user and authorizes sale and delivery of said wireless communication handset.

18. The system of claim 17, further comprising:
whereby said vending machine means performs programming of said handset to communicate with said platform using said first and second handset identification numbers.

19. A method for coupling a cellular phone and a telecommunication platform, the method comprising the steps of:
connecting a wireless communication handset to a telecommunications platform through a wireless carrier network;
programming at least one secret handset identification number and at least one public handset identification number coupled to said handset;
directing an outgoing call from said handset to said platform using said secret handset identification number and completing said outgoing call from said platform;
directing an incoming call from a third party to said platform;
retrieving said secret handset identification number corresponding to said public handset identification number dialed by said third party; and
completing said incoming call from said platform by dialing said secret handset identification number and connecting said incoming call to said handset.

20. The method of claim 19, wherein said secret handset identification number is unknown to a user of said handset.
